(19) United States
(12) Patent Application Publication
(10) Pub. No.: US 2026/0201832 A1
(43) Pub. Date: Jul. 16, 2026

(54) Hybrid Engine System

(71) Applicant: General Electric Company, Evendale, OH (US)

(72) Inventors: Jeffrey D. RAMBO, Mason, OH (US); Darek ZATORSKI, Fort Wright, KY (US)

(21) Appl. No.: 19/019,700

(22) Filed: Jan. 14, 2025

(51) Int. Cl. F02C 6/00; F02C 7/36

(52) U.S. Cl. CPC F02C 6/00; F02C 7/36; F05D 2220/76

(57) ABSTRACT

A hybrid engine system includes a duct, a turbine engine disposed within the duct, the turbine engine including a fan section, a compressor section, a combustion section, a turbine section, and a shaft coupled to the compressor section, an electrical power generator mechanically coupled to the shaft, the electrical power generator being configured to convert at least a portion of mechanical power generated by the turbine engine into electrical power, and a part-span inlet guide vane disposed upstream of the turbine engine within the duct, the part-span inlet guide vane including inlet guide vanes that are rotatable to control an amount of airflow and a direction of the airflow towards the fan section of the turbine engine.

### TECHNICAL FIELD

The present disclosure relates generally to a hybrid engine system.

### BACKGROUND

Turbine engines generally include a fan and a turbomachine arranged in flow communication with one another. The fan includes a plurality of airfoils or blades coupled to a rotor assembly.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1A is a schematic, cross-sectional diagram of a hybrid engine system including a turbine engine and an electrical power generator arranged in a first configuration, according to an embodiment of the present disclosure.

FIG. 1B is a schematic, cross-sectional diagram of a hybrid engine system comprising a turbine engine and an electrical power generator arranged in a second configuration, according to another embodiment of the present disclosure.

FIG. 2 shows a schematic, enlarged, cross-sectional view of detail 2 of the turbine engine and a part-span inlet guide vane, shown in FIG. 1A, according to an embodiment of the present disclosure.

FIG. 3 is a schematic, cross-sectional diagram of a hybrid engine including a turbine engine and an electrical power generator, according to an embodiment of the present disclosure.

### DETAILED DESCRIPTION

Features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “low” and “high,” or their respective comparative degrees (e.g., “lower” and “higher,” where applicable), when used with the compressor, turbine, shaft, or spool components, each refers to relative pressures and/or relative speeds within an engine unless otherwise specified. For example, a “low-speed” component defines a component configured to operate at a rotational speed, such as a maximum allowable rotational speed, which is lower than that of a “high-speed” component of the engine. Alternatively, unless otherwise specified, the aforementioned terms may be understood in their superlative degree. For example, a “low-pressure turbine” may refer to the lowest maximum pressure within a turbine section, and a “high-pressure turbine” may refer to the highest maximum pressure within the turbine section. The terms “low” or “high” in such aforementioned regards may additionally, or alternatively, be understood as relative to minimum allowable speeds and/or pressures, or minimum or maximum allowable speeds and/or pressures relative to normal, desired, steady state, etc., operation of the engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the term “axial” refers to directions and orientations that extend substantially parallel to a longitudinal centerline of the turbine engine. Moreover, the terms “radial” and “radially” refer to directions and orientations that extend substantially perpendicular to the longitudinal centerline of the turbine engine. In addition, as used herein, the term “circumferentially” refers to directions and orientations that extend arcuately about the longitudinal centerline of the turbine engine.

The present disclosure provides a hybrid engine system having a turbo-electric convertible engine architecture including a split inlet guide vane (IGV) and an electrical power generator.

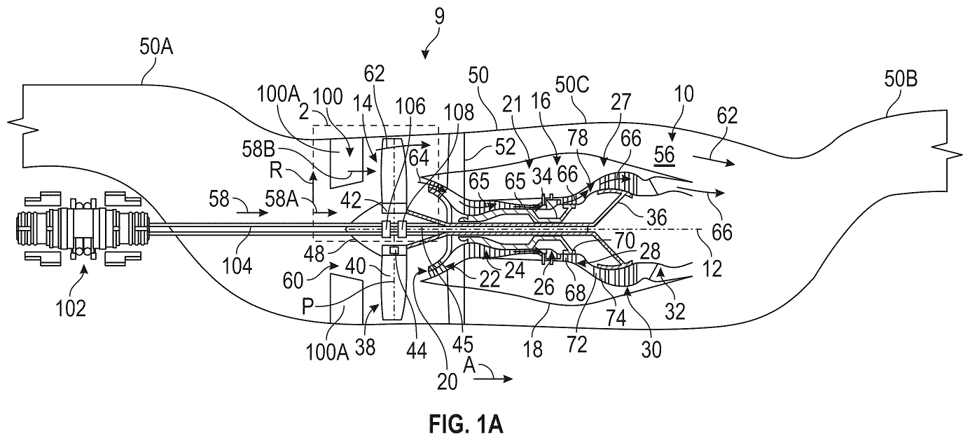

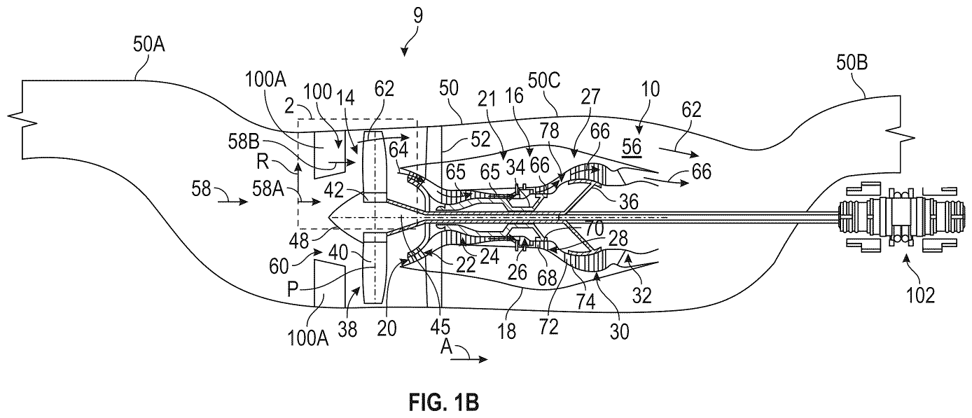

Referring now to the drawings, FIG. 1A is a schematic, cross-sectional diagram of a hybrid engine system 9 including a turbine engine 10 and an electrical power generator 102 arranged in a first configuration, according to an embodiment of the present disclosure. As shown in FIG. 1A, the turbine engine 10 of the hybrid engine system 9 defines an axial direction A (extending parallel to a longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 depicted in FIG. 1A generally includes an outer casing 18 that is substantially tubular and defines an annular inlet 20. As schematically shown in FIG. 1A, the outer casing 18 encases, in serial flow relationship, a compressor section 21 including a booster or a low-pressure (LP) compressor 22 followed downstream by a high-pressure (HP) compressor 24, a combustion section 26, a turbine section 27 including a high-pressure (HP) turbine 28 followed downstream by a low-pressure (LP) turbine 30, and a jet exhaust nozzle section 32. A high-pressure (HP) shaft 34 or a spool drivingly connects the HP turbine 28 to the HP compressor 24, to rotate the HP turbine 28 and the HP compressor 24 in unison. A low-pressure (LP) shaft 36 or a spool drivingly connects the LP turbine 30 to the LP compressor 22, to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1A, the fan section 14 includes a fan 38 (e.g., a variable pitch fan) having a plurality of fan blades 40 (airfoils) coupled to a disk 42 in a spaced apart manner. As depicted in FIG. 1A, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36. The disk 42 is covered by a fan hub 48 aerodynamically contoured to promote an airflow through the plurality of fan blades 40. The fan hub 48 is rotatable.

Referring still to the embodiment of FIG. 1A, the hybrid engine system 9 includes a duct 50. The duct 50 circumferentially surrounds the fan 38 and at least a portion of the turbo-engine 16. In an embodiment, as shown in FIG. 1A, the duct 50 surrounds a totality of the turbo-engine 16. The duct 50 is supported relative to the turbo-engine 16 by a plurality of circumferentially spaced outlet guide vanes 52 (stator airfoils). The duct 50 has an upstream duct portion 50A (inlet duct), a downstream duct portion 50B (outlet duct), a mid-duct portion 50C located between the upstream duct portion 50A and the downstream duct portion 50B. In an embodiment, as shown in FIG. 1A, the mid-duct portion 50C of the duct 50 extends over an outer portion of the turbo-engine 16, and the fan section 14 is located within the mid-duct portion 50C. The mid-duct portion 50C of the duct 50 defines a bypass duct 56 between the duct 50 and the turbo-engine 16.

The hybrid engine system 9 also includes a part-span inlet guide vane (PSIGV) 100. The part-span inlet guide vane 100 is provided between the upstream duct portion 50A of the duct 50 and the mid-duct portion 50C of the duct 50. The part-span inlet guide vane 100 operates as a variable airflow inlet guide vane to control airflow towards the fan section 14. In an embodiment, the part-span inlet guide vane 100 has a variable inlet 60 that is variable to control an amount of airflow towards the fan section 14. In an embodiment, the part-span inlet guide vane 100 includes inlet guide vanes 100A that are rotatable to control an amount of airflow and direction towards the fan section 14. In this embodiment, incoming airflow 58 is split into an inner radial airflow 58A that passes through the variable inlet 60 and an outer radial airflow 58B that passes between the inlet guide vanes 100A of the part-span inlet guide vane 100. For example, by rotating the inlet guide vanes 100A, the amount of outer radial airflow 58B passing between the inlet guide vanes 100A can be varied. In another embodiment, the part-span inlet guide vane 100 may not be provided with the variable inlet 60. In this case, the incoming airflow 58 is not split and is regulated by the inlet guide vanes 100A of the part-span inlet guide vane 100. In this case, the incoming airflow 58 passes between the inlet guide vanes 100A. As a result, the incoming airflow 58 passing between the inlet guide vanes 100A is varied by rotating the inlet guide vanes 100A.

During operation of the turbine engine 10, a volume of airflow 58 enters the turbine engine 10 through the variable inlet 60 (variable inlet) in the part-span inlet guide vane 100. The part-span inlet guide vane 100 changes a turning angle of the inlet guide vanes 100A (e.g., the inlet airflow is aligned to the axial direction without a circumferential angle) into the fan blades 40 to adjust the amount of airflow 58 towards the fan blades 40. As a result, the fan 38 does not pump the airflow as intended.

In normal operation, as the volume of airflow 58 passes across the fan blades 40 (rotating airfoils), a first portion of airflow 62 is directed or routed into the bypass duct 56, and a second portion of airflow 64 is directed or is routed into the upstream section of the core air flowpath, or, more specifically, into the annular inlet 20 of the LP compressor 22. The ratio between the first portion of the airflow 62 and the second portion of the airflow 64 is commonly known as a bypass ratio. The pressure of the second portion of the airflow 64 is then increased, generating compressed air 65, and the compressed air 65 is routed through the HP compressor 24 and into the combustion section 26, where the compressed air 65 is mixed with fuel and burned to generate combustion gases 66.

The combustion gases 66 are routed into the HP turbine 28 and expanded through the HP turbine 28 where a portion of thermal energy or kinetic energy, or both, from the combustion gases 66 is extracted via sequential stages of HP turbine stator vanes 68 (stator airfoils) that are coupled to the outer casing 18 and HP turbine rotor blades 70 (rotating airfoils) that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of the thermal energy of the kinetic energy, or both, is extracted from the combustion gases 66 via sequential stages of LP turbine stator vanes 72 (stator airfoils) that are coupled to the outer casing 18 and LP turbine rotor blades 74 (rotating airfoils) that are coupled to the LP shaft 36, thus, causing the LP shaft 36 to rotate, thereby supporting operation of the LP compressor 22 and rotation of the fan 38.

The combustion gases 66 are subsequently routed through the jet exhaust nozzle section 32 of the turbo-engine 16. Simultaneously, the pressure of the first portion of the airflow 62 is substantially increased as the first portion of the airflow 62 is routed through the bypass duct 56 before being exhausted through the downstream duct portion 50B of the duct 50. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1A is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbofan engines, propfan engines, turbojet engines, turboprop, and/or turboshaft engines.

For example, in an embodiment, the turbine engine may include a multistage or a plurality of fans 38 having a plurality or rows of fan blades 40. The rows of blades can be separated by one or more part-span inlet guide vanes placed in front of one or more rows of fan blades 40.

As shown in FIG. 1A, the hybrid engine system 9 also includes an electrical power generator 102 located upstream of the part-span inlet guide vane 100. In an embodiment, as shown in FIG. 1A, the electrical power generator 102 is located outside of the duct 50. The electrical power generator 102 is connected to the fan shaft 45 via a transmission shaft 104. In an embodiment, the electrical power generator 102 is aligned with the longitudinal centerline axis 12 of the turbine engine 10. A rotation of the fan shaft 45 can be transmitted to the transmission shaft 104, which, then, provides mechanical power to the electrical power generator 102. The electrical power generator 102 is configured to convert mechanical power into electrical power. The electrical power generator 102 is mechanically coupled to the fan shaft 45 and is configured to convert at least a portion of mechanical power generated by the turbine engine 10 into electrical power. In the first configuration, shown in FIG. 1A, the electrical power generator 102 is shown being connected to the fan shaft 45 via the transmission shaft 104 and, thus, is provided upstream of the turbine engine 10. In an embodiment, the transmission shaft 104 can be the same as the fan shaft 45. In an embodiment, the electrical power generator 102 is located outside of the upstream duct portion 50A.

In an embodiment, the electrical power generator 102 may be integrated with the LP compressor 22 of the turbine engine 10. The LP compressor 22 of the turbine engine 10 is rotatably connected to the electrical power generator 102. A clutch 106 can be provided for mechanically decoupling the LP shaft 36 from the electrical power generator 102. This configuration can be used to eliminate parasitic torque on the turbine engine 10 is used for propulsion when high thrust is used and the electrical power generator 102 is not being used. Additionally, the mechanical coupling of the LP shaft 36 to the electrical power generator 102 may include a gearbox 108 such that a rotation speed of the electrical power generator 102 is different from that of LP compressor 22 of the turbine engine 10.

FIG. 1B is a schematic, cross-sectional diagram of the hybrid engine system 9 comprising the turbine engine 10 and the electrical power generator 102 arranged in a second configuration, according to another embodiment of the present disclosure. In the second configuration, the electrical power generator 102 can be connected to the LP shaft 36 downstream of the turbine engine 10. In an embodiment, the electrical power generator 102 is located outside of the downstream duct portion 50B (outlet duct) of the duct 50. For example, the second configuration provides the ability to free more space near the fan shaft 45 to include a gearbox near the fan 38. In the first configuration, shown in FIG. 1A, a gearbox is not included, thus, enabling coupling the electrical power generator 102 to the turbine engine 10 via the transmission shaft 104 to the fan shaft 45.

The part-span inlet guide vane 100 can be configured to reduce the amount of the airflow 58 passing through the part-span inlet guide vane 100 towards the fan 38 to transfer power to the electrical power generator 102. The part-span inlet guide vane 100 can also be configured to be opened by rotating the inlet guide vanes 100A to increase the amount of airflow 58 towards the fan 38 to enable the turbine engine 10 to generate thrust.

For example, the part-span inlet guide vane 100 can change a turning angle of the inlet guide vanes 100A into the fan blades 40 so that the fan 38 does not pump airflow as intended (e.g., the inlet airflow is aligned to the axial direction without a circumferential angle). The fan blades 40 in turn do no transfer power to the airflow while the turbo-engine 16 and specifically low power turbine is still making shaft power as if the fan 38 were functioning as aerodynamically designed. The power generated by the turbo-engine 16 is available to the electrical power generator 102. The intentional mistuning of the fan aerodynamics is applied only to the portion of the air passing into the bypass duct 56. The inner radial portion of the fan blade 40 operates as designed independent of the positions of the inlet guide vanes of the part-span inlet guide vane 100 and pressurizes airflow entering the turbo-engine 16. As the fan 38 is not pressurizing and driving as much airflow through the bypass duct 56, a contribution of the fan 38 to the thrust drops. A radial extent of the part-span inlet guide vane 100 is configured by considering both the power removed from the LP compressor 22 and transferred to the electrical power generator 102 as well as a desired pressure ratios across the inner span and the outer span of the fan blade 40.

In an embodiment, instead of using a clutch or a transmission to reduce the rotation of the fan 38, the fan 38 can be hydrodynamically engaged or disengaged by varying the opening or the closing of the variable inlet 60 of the part-span inlet guide vane 100. In an embodiment, the opening or closing, or both, of the part-span inlet guide vane 100 can be effectuated by changing an inlet guide vane discharge angle of inlet guide vanes 100A of the part-span inlet guide vane 100. The inlet guide vane discharge angle of the part-span inlet guide vane 100 guides air into the fan blades 40. This changes the amount of work the fan blades 40 does on the airflow resulting in drawing less power from the turbo-engine 16.

For example, the part-span inlet guide vane 100 can be rotated to change inlet guide vane discharge angle of the inlet guide vanes 100A such that the amount of airflow 58 towards the fan 38 is reduced or increased. When the pressure rise imparted to the airflow 58 towards the fan 38 is decreased, the fan 38 is considered to not be pumping airflow. When the pressure rise imparted to the airflow 58 towards the fan 38 is increased, the fan 38 is considered to be pumping airflow. When the fan 38 is not pumping airflow, the power of the turbine engine 10 is directed towards the electrical power generator 102 to generate electrical power.

In an embodiment, the part-span inlet guide vane 100 can be configured to generate pre-swirling of the incoming airflow 58 approaching the fan blades 40 in a favorable manner. For example, pre-swirling the outer radial airflow of the incoming airflow 58 that passes between the inlet guide vanes 100A at the outermost portions of the fan inlet duct can reduce flow separation losses or shock losses, or both, on the fan blades 40. This enables the fan 38 to operate at higher fan tip speeds with less efficiency loss. In an embodiment, the part-span inlet guide vane 100 can also be configured to reduce the turbulence levels of the inner radial airflow that passes through the variable inlet 60 at the radial inboard location.

In an embodiment, the inlet guide vanes 100A of the part-span inlet guide vane 100 can be rotated and oriented to produce an aerodynamically unfavorable inlet airflow angle to the fan 38 to reduce the fan power to the airflow 58 when the hybrid engine system 9 is configured to operate in power generation mode so that mechanical power is transferred from the turbine engine 10 to the electrical power generator 102.

In an embodiment, the inlet guide vanes 100A of the part-span inlet guide vane 100 can be rotated and oriented to produce an aerodynamically favorable inlet airflow angle to the fan 38 to increase the fan aerodynamic efficiency when the hybrid engine system 9 is configured to operate in thrust mode. In an embodiment, an aerodynamic shape of the inlet guide vanes 100A of the part-span inlet guide vane 100 may vary along a length of the inlet guide vanes 100A, such that a chord line of the inlet guide vanes, a camber line of the inlet guide vanes, turning angles of the inlet guide vanes, etc. may vary along the radial direction R.

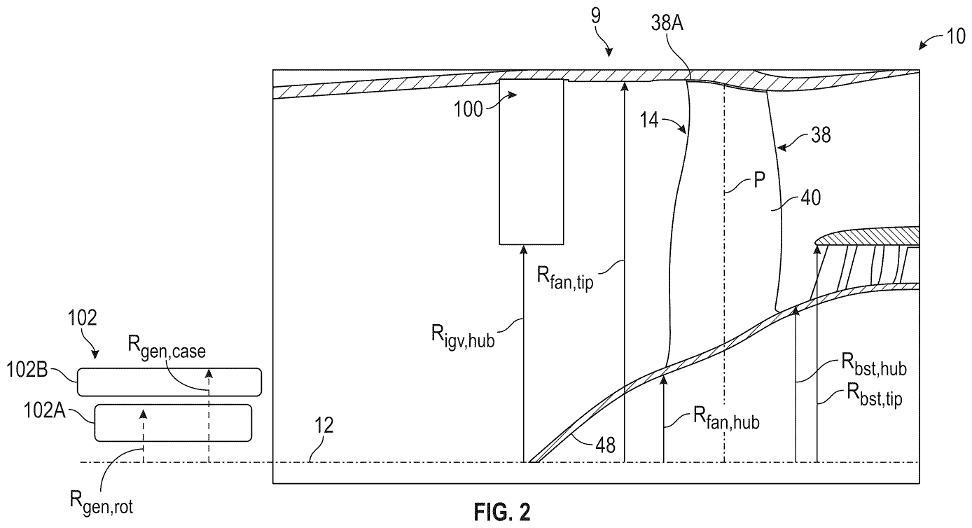

FIG. 2 shows a schematic, enlarged, cross-sectional view of detail 2 of the turbine engine 10 and the part-span inlet guide vane 100, shown in FIG. 1A, according to an embodiment of the present disclosure. FIG. 2 shows radii of various features of the turbine engine 10 measured from the longitudinal centerline axis 12. R_{igv,hub} represents a radius of the variable inlet 60 of the part-span inlet guide vane 100. R_{fan,tip} represents a radius of the fan 38 measured from the longitudinal centerline axis 12 to a tip 38A of the fan blade 40 of the fan 38. The tip 38A corresponds to a location with the maximum R_{fan,tip}. R_{fan, hub} represents a radius of the fan hub 48 measured from the longitudinal centerline axis 12. R_{bst,hub} represents a radius of the LP compressor 22 (booster) at the hub measured from the longitudinal centerline axis 12. R_{bst,tip} represents a radius of the LP compressor 22 (booster) measured from the centerline to the tip of the LP compressor 22. R_{gen,rot} represents a radius of a rotor 102A of the electrical power generator 102 measured from the longitudinal centerline axis 12. R_{gen,case} represents a radius of a case 102B of the electrical power generator 102 measured from the longitudinal centerline axis 12. In an embodiment, the various radii satisfy the following expressions.

The radius of the rotor of the electrical power generator 102 measured from the longitudinal centerline axis 12 is between 40% and 55% of a radius of the fan 38 in the fan section measured from the longitudinal centerline axis to a tip 38A of the fan 38. The tip 38A corresponds to a location with the maximum R_{fan,tip}.

$${R}_{g e n , rot} = \{ 0.40 - 0.55 \} * {R}_{fan , t i p} \qquad ( 1 )$$

The radius of the part-span inlet guide vane 100 is greater than 50% of the radius of the fan 38 in the fan section 14 measured from the longitudinal centerline axis 12 to the tip of the fan 38.

$${R}_{igv , hub} > 0.50 * {R}_{fan , tip} \qquad ( 2 )$$

A radius of the rotor 102A of the electrical power generator 102 measured from the longitudinal centerline is less than 1.1 of a radius of the part-span inlet guide vane 100 measured from the longitudinal centerline axis.

$${R}_{g e n , rot} < 1.1 * {R}_{igv , hub} \qquad ( 3 )$$

A ratio of a radius of the fan hub 48 of the fan 38 in the fan section 14 measured from the longitudinal centerline axis 12 to a radius of the tip of the fan 38 in the fan section 14 measured from the longitudinal centerline axis is between 0.25 and 0.35.

$$\frac{{R}_{fan , hub}}{{R}_{fan , tip}} = \{ 0.25 - 0.35 \} \qquad ( 4 )$$

A ratio of a radius of the fan hub 48 of the fan 38 in the fan section 14 measured from the longitudinal centerline axis 12 to a radius of a tip of the LP compressor 22 (booster) in the compressor section measured from the longitudinal centerline axis is between 0.70 and 0.80.

$$\frac{{R}_{bst , hub}}{{R}_{bst , tip}} = \{ 0.70 - 0.80 \} \qquad ( 5 )$$

The expression between the brackets { } provides a coefficient with possible values within an interval. For example, in expression (1), the interval is defined as values between 0.40 and 0.55 (e.g., between the 40% and 55%).

In an embodiment, a speed of rotation of the tip of the fan 38 is between thirteen hundred (1300) feet per second to fifteen hundred (1500) feet per second.

In an embodiment, a speed of rotation of the rotor of the electrical power generator is between six hundred (600) feet per second to seven hundred (700) feet per second.

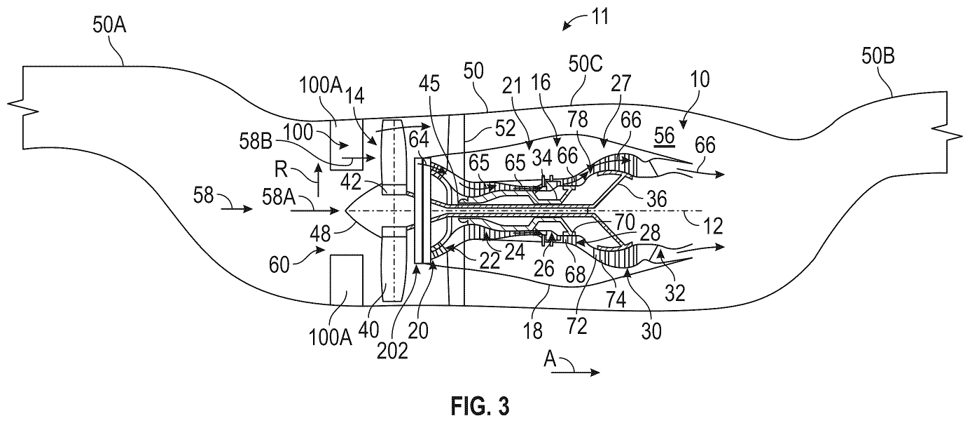

FIG. 3 is a schematic cross-sectional diagram of a hybrid engine system 11 comprising a turbine engine 10 and an electrical power generator 202, according to an embodiment of the present disclosure. The hybrid engine system 11 is similar in many aspects to the hybrid engine system 9 described above. For example, the hybrid engine includes the turbine engine 10 described above in detail. In this embodiment, the hybrid engine system 11 includes the electrical power generator 202 that is provided within the duct 50. Specifically, the electrical power generator 202 is disposed within the mid-duct portion 50C of the duct 50. In this embodiment, the electrical power generator 202 is disposed downstream of the fan 38 in the vicinity of the fan 38 and is connected to the fan shaft 45. In this embodiment, the electrical power generator 202 is integrated with the low-pressure (LP) compressor 22 of the compressor section 21.

Collocating the electrical power generator 202 with the LP compressor 22 allows to reduce the overall size of the turbine engine 10 and to eliminate structural challenges of having a long, unsupported shaft rotating at high speed. In addition, in the configurations shown in FIG. 1A and FIG. 1B, the electrical power generator 102 may use separate bearings to maintain the rotor of the electrical power generator 102 at a proper position within the electrical stator. On the other hand, the configuration shown in FIG. 3 uses the bearing of the turbine engine 10 to control the rotor position of electrical power generator 202.

The configuration shown in FIG. 3 combines the functionality when rotor magnets (in a permanent magnet generator, as compared to a wound field generator) are mounted outboard of the airfoils of the LP compressor 22, combining the rotor structure to mount both the airfoils of the LP compressor 22 and the magnets of the electrical power generator 202. Furthermore, a portion of the airflow of the LP compressor 22 may be extracted from the flow path and used to cool components of the electrical power generator 202. Conversely, the remotely positioned generator of FIG. 1A and FIG. 1B uses an auxiliary cooling system and airflow.

When the inlet guide vanes 100A of the part-span inlet guide vane 100 are rotated and oriented to produce an aerodynamically unfavorable inlet airflow angle to the fan 38 to reduce the fan power to the airflow 58, the hybrid engine system 9 is configured to operate in power generation mode so that mechanical power is transferred from the turbine engine 10 to the electrical power generator 102. When the inlet guide vanes 100A of the part-span inlet guide vane 100 is rotated and oriented to produce an aerodynamically favorable inlet airflow angle to the fan 38 to increase the fan aerodynamic efficiency, the hybrid engine system 9 is configured to operate in thrust mode.

Therefore, depending on the desired operation of the turbine engine 10 to provide thrust or to provide mechanical power to the electrical power generator 102, the part-span inlet guide vane 100 can be rotated as needed to produce an aerodynamically unfavorable inlet airflow angle to the fan 38 to reduce the fan power to the airflow 58 or to produce an aerodynamically favorable inlet airflow angle to the fan 38 to increase the fan aerodynamic efficiency.

Further aspects are provided by the subject matter of the following clauses.

A hybrid engine system includes a duct, a turbine engine disposed within the duct, the turbine engine including a fan section, a compressor section, a combustion section, a turbine section, and a shaft coupled to the compressor section, the turbine engine having a longitudinal centerline axis, an electrical power generator mechanically coupled to the shaft, the electrical power generator being configured to convert at least a portion of mechanical power generated by the turbine engine into electrical power, and a part-span inlet guide vane disposed upstream of the turbine engine within the duct, the part-span inlet guide vane including inlet guide vanes that are rotatable to control an amount of airflow and a direction of the airflow towards the fan section.

The hybrid engine system of the preceding clause, the electrical power generator being aligned with the longitudinal centerline axis.

The hybrid engine system of any preceding clause, the electrical power generator being located outside of the duct and upstream of the turbine engine.

The hybrid engine system of any preceding clause, the electrical power generator being located inside the duct downstream of the fan section of the turbine engine.

The hybrid engine system of any preceding clause, the electrical power generator being located outside the duct downstream of the turbine engine.

The hybrid engine system of any preceding clause, the part-span inlet guide vane being configured to be closed to reduce the amount of airflow passing between the inlet guide vanes towards the fan section to transfer power to the electrical power generator.

The hybrid engine system of any preceding clause, the part-span inlet guide vane being configured to be opened to increase the amount of airflow passing between the inlet guide vanes towards the fan section to enable the turbine engine to generate thrust.

The hybrid engine system of any preceding clause, the part-span inlet guide vane being disposed between the turbine engine and the electrical power generator.

The hybrid engine system of any preceding clause, the electrical power generator being disposed downstream of the fan section in a vicinity of the fan section.

The hybrid engine system of any preceding clause, the electrical power generator being integrated with a low-pressure compressor of the compressor section.

The hybrid engine system of any preceding clause, a radius of the part-span inlet guide vane measured from the longitudinal centerline axis being greater than 50% of a radius of a fan in the fan section measured from the longitudinal centerline axis.

The hybrid engine system of any preceding clause, a ratio of a radius of a hub of a fan in the fan section measured from the longitudinal centerline axis to a radius of a tip of the fan in the fan section measured from the longitudinal centerline axis being between 0.25 and 0.35.

The hybrid engine system of any preceding clause, a ratio of a radius of a hub of a fan in the fan section measured from the longitudinal centerline axis to a radius of a tip of a low-pressure compressor in the compressor section measured from the longitudinal centerline axis being between 0.70 and 0.80.

The hybrid engine system of any preceding clause, the compressor section including a low-pressure compressor, the turbine section includes a low-pressure turbine, and the fan section includes a fan shaft, the fan shaft being coupled to a low-pressure shaft, and the low-pressure shaft connects the low-pressure turbine to the low-pressure compressor to rotate the low-pressure turbine and the low-pressure compressor in unison.

The hybrid engine system of any preceding clause, the shaft including a fan shaft coupled to a fan in the fan section, and the electrical power generator is mechanically coupled to the fan shaft.

The hybrid engine system of any preceding clause, the shaft including a transmission shaft connected to the fan shaft to transmit mechanical power from the turbine engine to the electrical power generator.

The hybrid engine system of any preceding clause, a radius of a rotor of the electrical power generator measured from the longitudinal centerline axis being between 40% and 50% of a radius of a tip of a fan in the fan section measured from the longitudinal centerline axis.

The hybrid engine system of any preceding clause, a speed of rotation of the tip of the fan being between thirteen hundred (1300) feet per second to fifteen hundred (1500) feet per second.

The hybrid engine system of any preceding clause, a radius of a rotor of the electrical power generator measured from the longitudinal centerline axis being less than 1.1 of a radius of the part-span inlet guide vane measured from the longitudinal centerline axis.

The hybrid engine system of any preceding clause, a speed of rotation of the rotor of the electrical power generator being between six hundred (600) feet per second and seven hundred (700) feet per second.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A hybrid engine system, comprising:
a duct;
a turbine engine disposed within the duct, the turbine engine comprising a fan section, a compressor section, a combustion section, a turbine section, and a shaft coupled to the compressor section, the turbine engine having a longitudinal centerline axis;
an electrical power generator mechanically coupled to the shaft, the electrical power generator being configured to convert at least a portion of mechanical power generated by the turbine engine into electrical power; and
a part-span inlet guide vane disposed upstream of the turbine engine within the duct, the part-span inlet guide vane including inlet guide vanes that are rotatable to control an amount of airflow and a direction of the airflow towards the fan section of the turbine engine.

2. The hybrid engine system of claim 1, wherein the electrical power generator is aligned with the longitudinal centerline axis.

3. The hybrid engine system of claim 1, wherein the electrical power generator is located outside of the duct and upstream of the turbine engine.

4. The hybrid engine system of claim 1, wherein the electrical power generator is located inside the duct downstream of the fan section of the turbine engine.

5. The hybrid engine system of claim 1, wherein the electrical power generator is located outside the duct downstream of the turbine engine.

6. The hybrid engine system of claim 1, wherein the part-span inlet guide vane is configured to be closed to reduce the amount of airflow passing between the inlet guide vanes towards the fan section to transfer power to the electrical power generator.

7. The hybrid engine system of claim 1, wherein the part-span inlet guide vane is configured to be opened to increase the amount of airflow passing between the inlet guide vanes towards the fan section to enable the turbine engine to generate thrust.

8. The hybrid engine system of claim 1, wherein the part-span inlet guide vane is disposed between the turbine engine and the electrical power generator.

9. The hybrid engine system of claim 1, wherein the electrical power generator is disposed downstream of the fan section in a vicinity of the fan section.

10. The hybrid engine system of claim 1, wherein the electrical power generator is integrated with a low-pressure compressor of the compressor section.

11. The hybrid engine system of claim 1, wherein a radius of the part-span inlet guide vane measured from the longitudinal centerline axis is greater than 50% of a radius of a fan in the fan section measured from the longitudinal centerline axis.

12. The hybrid engine system of claim 1, wherein a ratio of a radius of a hub of a fan in the fan section measured from the longitudinal centerline axis to a radius of a tip of the fan in the fan section measured from the longitudinal centerline axis is between 0.25 and 0.35.

13. The hybrid engine system of claim 1, wherein a ratio of a radius of a hub of a fan in the fan section measured from the longitudinal centerline axis to a radius of a tip of a low-pressure compressor in the compressor section measured from the longitudinal centerline axis is between 0.70 and 0.80.

14. The hybrid engine system of claim 1, wherein the compressor section comprises a low-pressure compressor, the turbine section comprises a low-pressure turbine, and the fan section comprises a fan shaft, wherein the fan shaft is coupled to a low-pressure shaft, and the low-pressure shaft connects the low-pressure turbine to the low-pressure compressor to rotate the low-pressure turbine and the low-pressure compressor in unison.

15. The hybrid engine system of claim 1, wherein the shaft includes a fan shaft coupled to a fan in the fan section, and the electrical power generator is mechanically coupled to the fan shaft.

16. The hybrid engine system of claim 15, wherein the shaft includes a transmission shaft connected to the fan shaft to transmit mechanical power from the turbine engine to the electrical power generator.

17. The hybrid engine system of claim 1, wherein a radius of a rotor of the electrical power generator measured from the longitudinal centerline axis is between 40% and 50% of a radius of a tip of a fan in the fan section measured from the longitudinal centerline axis.

18. The hybrid engine system of claim 17, wherein a speed of rotation of the tip of the fan is between thirteen hundred (1300) feet per second to fifteen hundred (1500) feet per second.

19. The hybrid engine system of claim 1, wherein a radius of a rotor of the electrical power generator measured from the longitudinal centerline axis is less than 1.1 of a radius of the part-span inlet guide vane measured from the longitudinal centerline axis.

20. The hybrid engine system of claim 19, wherein a speed of rotation of the rotor of the electrical power generator is between six hundred (600) feet per second and seven hundred (700) feet per second.
